(19) United States
(12) Patent Application Publication
(10) Pub. No.: US 2025/0392242 A1
(43) Pub. Date: Dec. 25, 2025

(54) MOTOR CONTROL UNIT, MOTOR, AND PUMP DEVICE

(71) Applicant: NIDEC INSTRUMENTS CORPORATION, Nagano (JP)

(72) Inventor: Satoshi TANIMURA, Nagano (JP)

(73) Assignee: NIDEC INSTRUMENTS CORPORATION, Nagano (JP)

(21) Appl. No.: 18/878,865

(22) PCT Filed: Jun. 13, 2023
(86) PCT No.: PCT/JP2023/021929

§ 371 Date: Dec. 24, 2024

(30) Foreign Application Priority Data
Jun. 30, 2022 (JP) 2022-105851

(51) Int. Cl. H02P 23/04; H02K 11/33; H02P 25/16; H02P 27/08

(52) U.S. Cl. CPC H02P 23/04; H02K 11/33; H02P 25/16; H02P 27/08

(57) ABSTRACT

A motor control unit includes a drive voltage line that supplies a drive voltage to an inverter, a first capacitor electrically connected between a ground and a portion of the drive voltage line between the inverter and an inductor, a second capacitor electrically connected between the ground and a portion of the drive voltage line closer to an input side than the first capacitor, a third capacitor electrically connected between the second capacitor and the ground, a common line electrically connected to a neutral point of a three-phase coil and an intermediate point, and a resistor electrically connected in series to the second capacitor or the third capacitor.

### TECHNICAL FIELD

The present invention relates to a motor used in a pump device or the like. The present invention also relates to a motor control unit that controls the motor.

### BACKGROUND ART

Patent Literature 1 discloses a pump device. The pump of the literature includes a motor, an impeller fixed to a rotor of the motor, and a case accommodating the impeller and defining a pump chamber. The motor has the rotor that is rotatable about a central axis, and a stator core including a three-phase coil.

As the motor of the above pump device, a motor subjected to a noise countermeasure may be used (for example, Patent Literature 2). The motor of Patent Literature 2 has a control device including one capacitor arranged in parallel between a neutral point of a three-phase coil and a predetermined reference potential. Since the control device includes the capacitor, the voltage at the neutral point is smoothed. Accordingly, the noise generated from the motor is suppressed.

### CITATION LIST

### Patent Literature

Patent Literature 1: Japanese Unexamined Patent Publication No. 2020-159336
Patent Literature 2: Japanese Unexamined Patent Publication No. 2001-352792

### SUMMARY OF THE INVENTION

### Problems to be Solved by the Invention

A pump device has been increasingly used together with another precision device, and, in a case where the pump device is used for a purpose such as an in-vehicle pump, the noise generated from a motor of the pump device is required to be further suppressed. In this case, there is a problem in that using only the motor of Patent Literature 2 in the pump device is not sufficient as a noise countermeasure.

Therefore, an object of the present invention is to provide a motor control unit capable of suppressing noise generated from a motor. Another object of the present invention is to provide a motor having the motor control unit and a pump device having the motor.

### Means for Solving the Problem

In order to solve the above problem, a motor control unit of the present invention is a motor control unit that controls a motor including a three-phase coil wound around a stator core, including: a motor control part that controls rotation of the motor by a control signal; an inverter that applies a drive voltage supplied from a drive power supply to the three-phase coil on the basis of an output signal from the motor control part; a drive voltage line that supplies the drive voltage to the inverter; an inductor electrically connected in series to the drive voltage line; a first capacitor electrically connected between a ground and a portion of the drive voltage line between the inverter and the inductor; a second capacitor electrically connected between the ground and a portion of the drive voltage line closer to an input side than the first capacitor; a third capacitor electrically connected between the second capacitor and the ground; a common line electrically connected to a neutral point of the three-phase coil and an intermediate point between the second capacitor and the third capacitor; and a resistor electrically connected in series to the second capacitor or the third capacitor.

In the present invention, the inductor electrically connected in series to the drive voltage line, and the first capacitor electrically connected between the ground and a portion of the drive voltage line between the inverter and the inductor are included. According to this configuration, since a drive voltage flowing through the drive voltage line is able to be smoothed, the noise generated in the drive voltage line may be suppressed.

Moreover, in the present invention, the second capacitor electrically connected between the ground and a portion of the drive voltage line closer to the input side than the first capacitor, the third capacitor electrically connected between the second capacitor and the ground, and the common line electrically connected to the neutral point of the three-phase coil and the intermediate point between the second capacitor and the third capacitor are included. According to this configuration, since the neutral point electrically connected to the common line is clamped by the second capacitor and the third capacitor, even when a voltage having a relatively large amplitude is generated at the neutral point, the voltage is able to be smoothed. Accordingly, the noise generated in the motor may be suppressed.

Furthermore, in the present invention, the resistor electrically connected in series to the second capacitor or the third capacitor is included. According to this configuration, even when a voltage having a relatively large amplitude is generated at the neutral point, the voltage is able to be smoothed. Accordingly, the noise generated in the motor may be suppressed.

In the present invention, the resistor may include a first resistor electrically connected between a portion of the drive voltage line close to the input side and the second capacitor, and a second resistor electrically connected between the third capacitor and the ground. Moreover, in the present invention, the resistor may include a first resistor electrically connected between the second capacitor and the intermediate point, and a second resistor electrically connected between the intermediate point and the third capacitor. Accordingly, the noise generated in the motor may be suppressed.

In the present invention, when a resistance value of each of the first resistor and the second resistor is Ra, the following conditional expression:

$$100 Ω \leq R a$$

is preferably satisfied. Accordingly, the effect of suppressing the noise generated in the motor is large.

In the present invention, the resistor may be connected in series on the common line. In this case, when a resistance value of the resistor is Ra, the following conditional expression:

$$100 Ω \leq R a$$

is preferably satisfied. Accordingly, the effect of suppressing the noise generated in the motor is large.

In the present invention, when an electrostatic capacity of each of the second capacitor and the third capacitor is C1, the following conditional expression:

$$1. μ F \leq C 1 \leq 4.7 μF$$

is preferably satisfied. When the electrostatic capacity C1 of each of the second capacitor and the third capacitor is smaller than 1.0 μF, the voltage at the neutral point cannot be sufficiently smoothed, and the effect of reducing the noise generated in the motor is relatively low. In addition, when each electrostatic capacity C1 is larger than 4.7 μF, the voltage at the neutral point is excessively smoothed, so that the rotation characteristics of the motor are relatively deteriorated. Accordingly, it becomes difficult to deliver the performance of the motor. Therefore, when the electrostatic capacity C1 of each of the second capacitor and the third capacitor satisfies 1.0 μF≤C1≤4.7 μF, the noise generated in the motor may be suppressed without deteriorating the rotation characteristics of the motor.

In the present invention, the second capacitor is preferably electrically connected between the ground and a portion of the drive voltage line closer to the input side than the inductor. According to this configuration, the effect of suppressing the noise generated in the motor is larger than when the second capacitor is electrically connected between the ground and a portion of the drive voltage line closer to the output side than the inductor.

In the present invention, when an electrostatic capacity of the first capacitor is C2, the following conditional expression:

$$100 μF \leq C 2$$

is preferably satisfied. When the electrostatic capacity C2 of the first capacitor is smaller than 100 μF, the current ripple tends to be relatively large, and the drive voltage flowing through the drive voltage line cannot be sufficiently smoothed. Thus, it is difficult to effectively suppress the noise generated in the drive voltage line. Therefore, when the electrostatic capacity C2 of the first capacitor satisfies 100 μF≤C2, the noise generated in the voltage line may be suppressed. In addition, since the current ripple is suppressed, the first capacitor does not excessively generate heat. Therefore, the characteristics and reliability of the first capacitor are able to be ensured.

In the present invention, a control signal line for inputting the control signal to the motor control part; and a fourth capacitor electrically connected between the control signal line and the ground are preferably included. According to this configuration, since the control signal to be transmitted through the control signal line is able to be smoothed, the noise generated in the control signal line may be removed.

In the present invention, a ferrite bead electrically connected in series to the control signal line in a portion of the control signal line closer to an input side than the fourth capacitor; and a sixth capacitor electrically connected between the ground and a portion of the control signal line closer to the input side than the ferrite bead are preferably included. According to this configuration, the noise generated in the control signal line may be further removed.

In the present invention, an FG output line for transmitting a rotation speed signal corresponding to a rotation speed of the motor to an external device; and a fifth capacitor electrically connected between the FG output line and the ground are preferably included. According to this configuration, since the rotation speed signal to be transmitted through the FG output line is able to be smoothed, the noise generated in the FG output line may be removed.

In the present invention, when an electrostatic capacity of the fifth capacitor is C3, the following conditional expression:

$$C 3 \leq 0.1 μF$$

is preferably satisfied. When the electrostatic capacity C3 of the fifth capacitor is larger than 0.1 μF, the noise generated in the FG output line is able to be removed, but the output waveform of the rotation speed signal tends to be relatively dull. Thus, since the external device cannot accurately detect the rotation speed signal of the motor, it becomes difficult to control the motor to a desired rotation speed. Therefore, when the electrostatic capacity C3 of the fifth capacitor satisfies C3≤0.1 μF, the noise generated in the FG output line may be removed and the motor may be controlled to a desired rotation speed.

A motor of the present invention includes: a rotor that is rotatable about a central axis; a stator core including a three-phase coil; and the motor control unit described above. According to this configuration, the noise generated in the motor may be suppressed.

A pump device of the present invention includes: the motor described above; an impeller fixed to the rotor; and a case accommodating the impeller and defining a pump chamber. According to this configuration, the noise generated from the pump device is suppressed, and thus a precision device used around the pump device is less likely to be affected by the noise.

### Effect of the Invention

According to the present invention, since the drive voltage flowing through the drive voltage line is able to be smoothed by the inductor and the first capacitor, the noise generated in the drive voltage line may be suppressed. Moreover, since the neutral point electrically connected to the common line is clamped by the second capacitor and the third capacitor and the resistor is electrically connected in series to the second capacitor or the third capacitor, even when a voltage having a relatively large amplitude is generated at the neutral point, the voltage is able to be smoothed. Accordingly, the motor control unit may suppress the noise generated in the motor.

### BRIEF DESCRIPTION OF THE DRAWINGS

FIG. 1 is an explanatory diagram schematically illustrating a cross-section of a pump device according to embodiments of the present invention.

FIG. 2 is a schematic circuit diagram of a motor control unit of a first embodiment.

FIG. 3 is a schematic circuit diagram of a motor control unit of a comparative example.

FIG. 4 is a diagram for explaining a noise-reduction effect.

FIG. 5 is a diagram illustrating a noise peak value when a resistance value Ra and an electrostatic capacity C1 are changed.

FIG. 6 is a diagram illustrating a comparison between electrostatic capacities of capacitors.

FIG. 7 is a schematic circuit diagram of a motor control unit of a second embodiment.

FIG. 8 is a schematic circuit diagram of a motor control unit of another embodiment.

### DETAILED DESCRIPTION

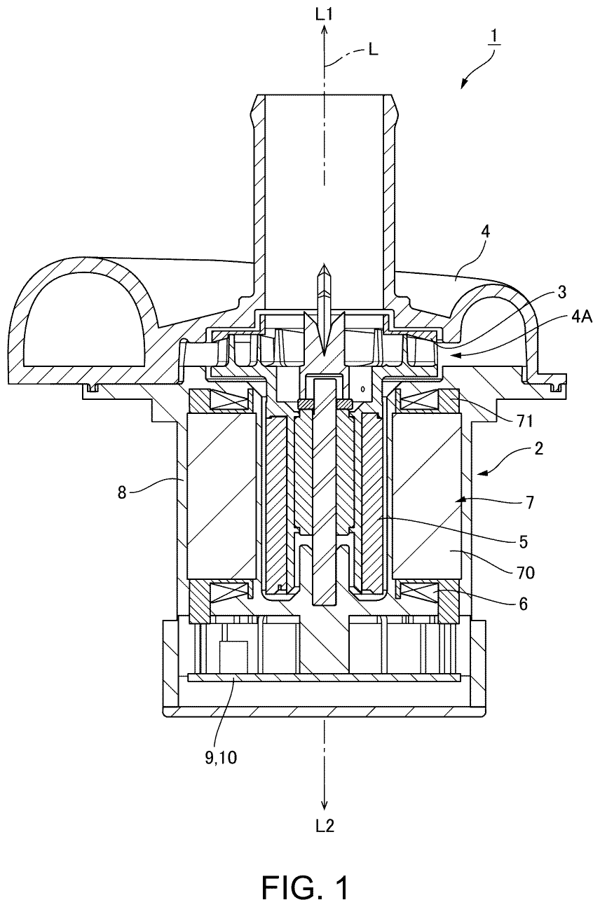

Hereinafter, embodiments of the present invention will be described with reference to the drawings. FIG. 1 is an explanatory diagram schematically illustrating a cross-section of a pump device according to the embodiments of the present invention. As illustrated in FIG. 1, a pump device 1 has a motor 2 including a rotor 5 that is rotatable about a central axis L, an impeller 3 fixed to one side L1 of the central axis L with respect to the rotor 5, and a case 4 accommodating the impeller 3 and defining a pump chamber 4A. The case 4 is attached to the motor 2 from the one side L1 of the motor 2. In the pump device 1, the impeller 3 rotates about the central axis L integrally with the rotor 5 to move a fluid in the pump chamber 4A.

The motor 2 includes the rotor 5 that is rotatable about the central axis L, a stator 7 including a three-phase coil 6, a resin sealing member 8 covering the stator 7, and a circuit board 9 connected to the three-phase coil 6. The motor 2 is a three-phase motor, and the three-phase coil 6 includes a U-phase coil, a V-phase coil, and a W-phase coil. The three-phase coil 6 is wound around a stator core 70 of the stator 7 via an insulator 71. A magnet is provided on the outer peripheral surface of the rotor 5.

The circuit board 9 is located on the other side L2 of the stator 7. On the circuit board 9, a motor control unit 10 for controlling the motor 2 is configured. The motor control unit 10 controls the rotation of the motor 2 by controlling power feeding to the three-phase coil 6.

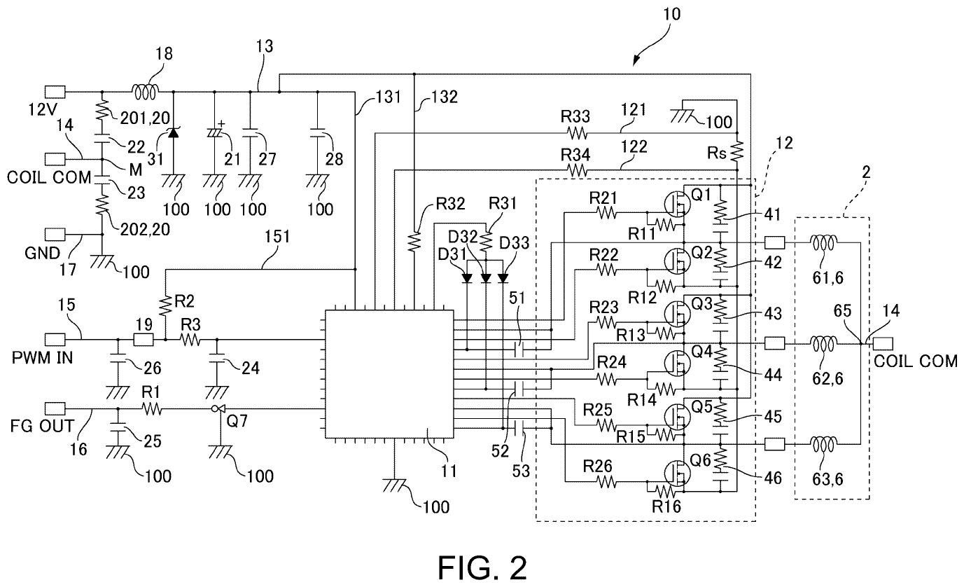

FIG. 2 is a schematic circuit diagram of the motor control unit 10. As illustrated in FIG. 2, the motor 2 controlled by the motor control unit 10 includes a U-phase coil 61, a V-phase coil 62, and a W-phase coil 63. The three-phase coil 6 is star-connected.

The motor control unit 10 includes a motor control part 11 that controls the rotation of the motor 2 by a PWM signal, an inverter 12 that applies a drive voltage supplied from a drive power supply to the three-phase coil 6 on the basis of an output signal from the motor control part 11, a drive voltage line 13 that supplies the drive voltage to the inverter 12, and a common line 14 connected to a neutral point 65 of the three-phase coil 6. The motor control unit 10 includes a control signal line 15 for inputting a PWM signal from an external device to the motor control part 11, and an FG output line 16 for transmitting a rotation speed signal corresponding to the rotation speed of the motor 2 to the external device.

The motor control unit 10 has an inductor 18, a first capacitor 21, a second capacitor 22, a third capacitor 23, a fourth capacitor 24, a fifth capacitor 25, a sixth capacitor 26, a ferrite bead 19, and a resistor 20.

The motor control part 11 includes an IC chip or the like arranged on the circuit board 9. The motor control part 11 outputs an output signal for controlling the inverter 12 on the basis of a PWM signal input from an external device. Moreover, the motor control part 11 outputs a rotation speed signal corresponding to the rotation speed of the rotor 5 to the external device. The external device outputs the PWM signal to the motor control part 11 on the basis of the rotation speed signal in order to set the motor 2 to a desired rotation speed.

The inverter 12 includes switching elements Q1 and Q2 constituting upper and lower arms for a U phase, switching elements Q3 and Q4 constituting upper and lower arms for a V phase, and switching elements Q5 and Q6 constituting upper and lower arms for a W phase. For example, a MOS-type FET is used for each of the switching elements Q1 to Q6.

A drain of the switching element Q1, a drain of the switching element Q3, and a drain of the switching element Q5 are connected to the drive voltage line 13. A source of the switching element Q2, a source of the switching element Q4, and a source of the switching element Q6 are connected to a ground 100 via a shunt resistor Rs. Both ends of the shunt resistor Rs are connected to the motor control part 11 from an output line 121 and an output line 122 via resistors R33 and R34.

The U-phase coil 61 of the three-phase coil 6 is connected to a source of the switching element Q1 and a drain of the switching element Q2. The V-phase coil 62 of the three-phase coil 6 is connected to a source of the switching element Q3 and a drain of the switching element Q4. The W-phase coil 63 of the three-phase coil 6 is connected to a source of the switching element Q5 and a drain of the switching element Q6.

A capacitor 51 is connected to the source of the switching element Q1 and the drain of the switching element Q2 on the side opposite to the side on which the U-phase coil 61 of the three-phase coil 6 is connected. A capacitor 52 is connected to the source of the switching element Q3 and the drain of the switching element Q4 on the side opposite to the side on which the V-phase coil 62 of the three-phase coil 6 is connected. A capacitor 53 is connected to the source of the switching element Q5 and the drain of the switching element Q6 on the side opposite to the side on which the W-phase coil 63 of the three-phase coil 6 is connected. The capacitors 51 to 53 serve as charging and discharging capacitors of a bootstrap circuit.

Bootstrap diodes D31 to D33 are connected between the capacitors 51 to 53 and the motor control part 11, respectively. The diodes D31 to D33 are connected to the motor control part 11 via a resistor R31.

Each of resistors R11 to R16 is connected between a gate and the source of each of the switching elements Q1 to Q6. Each of resistors R21 to R26 is connected between the gate of each of the switching elements Q1 to Q6 and the motor control part 11. Each of filters 41 to 46 is connected between the drain and the source of each of the switching elements Q1 to Q6. Each of the filters 41 to 46 is configured by a resistor and a capacitor connected in series.

The inverter 12 is a circuit that rotates the rotor 5 of the motor 2 by converting a drive voltage supplied from the drive voltage line 13 into a three-phase alternating current drive voltage by switching of the respective switching elements Q1 to Q6 and causing the three-phase alternating current drive voltage to flow through the motor 2. The inverter 12 drives the motor 2 on the basis of an output signal output from the motor control part 11.

The drive voltage line 13 supplies electric power to the motor control part 11 and the inverter 12. In the present embodiment, a rated voltage of 12 V is applied to the drive voltage line 13. The inductor 18 and the first capacitor 21 are connected to the drive voltage line 13. The inductor 18 is electrically connected in series to the drive voltage line 13. The first capacitor 21 is electrically connected between the ground and a portion of the drive voltage line 13 between the inverter 12 and the inductor 18. In the present embodiment, the electrostatic capacity C2 of the first capacitor 21 is 150 μF.

A capacitor 27 and a diode 31 are connected to the drive voltage line 13. The capacitor 27 is electrically connected between the ground 100 and a portion of the drive voltage line 13 closer to the output side than the first capacitor 21. The diode 31 is electrically connected between the ground 100 and a portion of the drive voltage line 13 between the inductor 18 and the first capacitor 21.

A first line 131 and a second line 132 are connected to the drive voltage line 13. The first line 131 and the second line 132 are electrically connected to the motor control part 11, and supply electric power to the motor control part 11. The first line 131 is branched on the output side of the capacitor 27 and is electrically connected to the motor control part 11. A capacitor 28 that is electrically connected to the ground 100 is connected to the first line 131. The second line 132 is electrically connected to the motor control part 11 via a resistor R32.

The second capacitor 22 is connected to the drive voltage line 13. The second capacitor 22 is electrically connected between the ground and a portion of the drive voltage line 13 closer to the input side than the first capacitor 21. More specifically, the second capacitor 22 is electrically connected between the ground and a portion of the drive voltage line 13 closer to the input side than the inductor 18. The third capacitor 23 is electrically connected between the second capacitor 22 and the ground 100. That is, the second capacitor 22 and the third capacitor 23 are connected in series between the drive voltage line 13 and the ground 100 in the drive voltage line 13 closer to the input side than the inductor 18. In the present embodiment, the second capacitor 22 and the third capacitor 23 are configured by the same capacitor. That is, the electrostatic capacity C1 of the second capacitor 22 and the electrostatic capacity C1 of the third capacitor 23 are the same. The electrostatic capacity C1 of each of the second capacitor 22 and the third capacitor 23 is preferably 1.0 μF≤C1≤4.7 μF.

The common line 14 is electrically connected to an intermediate point M between the second capacitor 22 and the third capacitor 23. That is, the neutral point 65 electrically connected to the common line 14 is clamped by the second capacitor 22 and the third capacitor 23. Moreover, a ground line 17 is connected between the third capacitor 23 and the ground 100.

The resistor 20 is electrically connected in series to the second capacitor 22 or the third capacitor 23. In the present embodiment, the resistor 20 includes a first resistor 201 electrically connected in series between a portion of the drive voltage line 13 close to the input side and the second capacitor 22, and a second resistor 202 electrically connected in series between the third capacitor 23 and the ground 100. In the present embodiment, the first resistor 201 and the second resistor 202 are configured by the same resistor. That is, the resistance values Ra of the first resistor 201 and the second resistor 202 are the same. The resistance values Ra of the first resistor 201 and the second resistor 202 are preferably 100Ω≤Ra.

The control signal line 15 transmits a PWM signal from an external device to the motor control part 11. The ferrite bead 19, the fourth capacitor 24, the sixth capacitor 26, and a resistor R3 are connected to the control signal line 15. The fourth capacitor 24 is electrically connected between the control signal line 15 and the ground 100. The ferrite bead 19 is electrically connected in series to the control signal line 15 in a portion of the control signal line 15 closer to the output side than the fourth capacitor 24. The sixth capacitor 26 is electrically connected between the ground 100 and a portion of the control signal line 15 closer to the output side than the ferrite bead 19. The resistor R3 is electrically connected in series to the control signal line 15 in a portion of the control signal line 15 closer to the output side than the sixth capacitor 26.

A third line 151 connected to the first line 131 is connected to the control signal line 15. The third line 151 is electrically connected to the control signal line 15 between the ferrite bead 19 and the resistor R3. A resistor R2 is electrically connected in series to the third line 151.

The FG output line 16 transmits a rotation speed signal of the motor 2 output from the motor control part 11 to an external device. The fifth capacitor 25, a resistor R1, and a NOT gate Q7 are connected to the FG output line 16. The fifth capacitor 25 is electrically connected between the FG output line 16 and the ground 100. The resistor R1 is electrically connected in series to the FG output line 16 in a portion of the FG output line 16 closer to the input side than the fifth capacitor 25. The NOT gate Q7 is electrically connected in series to the FG output line 16 in a portion of the FG output line 16 closer to the input side than the resistor R1. In the present embodiment, the electrostatic capacity C3 of the fifth capacitor 25 is 0.047 μF.

### (Operation and Effect)

The motor control unit 10 of the present embodiment has the inductor 18 electrically connected in series to the drive voltage line 13, and the first capacitor 21 electrically connected between the ground 100 and a portion of the drive voltage line 13 between the inverter 12 and the inductor 18. According to this configuration, since a drive voltage flowing through the drive voltage line 13 is able to be smoothed, the noise generated in the drive voltage line 13 may be suppressed.

Moreover, the motor control unit 10 of the present embodiment has the second capacitor 22 electrically connected between the ground 100 and a portion of the drive voltage line 13 closer to the input side than the first capacitor 21, and the third capacitor 23 electrically connected between the second capacitor 22 and the ground 100. The common line 14 is electrically connected to the neutral point 65 of the three-phase coil 6 and the intermediate point M between the second capacitor 22 and the third capacitor 23. Therefore, since the neutral point 65 electrically connected to the common line 14 is clamped by the second capacitor 22 and the third capacitor 23, even when a voltage having a relatively large amplitude is generated at the neutral point 65, the voltage is able to be smoothed. Accordingly, the noise generated in the motor 2 may be suppressed. Furthermore, since the second capacitor 22 is electrically connected between the ground 100 and a portion of the drive voltage line 13 closer to the input side than the inductor 18, the effect of suppressing the noise generated in the motor 2 is larger than when the second capacitor 22 is electrically connected between the ground 100 and a portion of the drive voltage line 13 closer to the output side than the inductor 18.

In addition, the motor control unit 10 of the present embodiment includes the resistor 20 electrically connected in series to the second capacitor 22 or the third capacitor 23. The resistor 20 includes the first resistor 201 electrically connected in series between a portion of the drive voltage line 13 close to the input side and the second capacitor 22, and the second resistor 202 electrically connected in series between the third capacitor 23 and the ground 100. In the present embodiment, the first resistor 201 and the second resistor 202 are configured by the same resistor. Therefore, the noise generated in the motor 2 is able to be further suppressed.

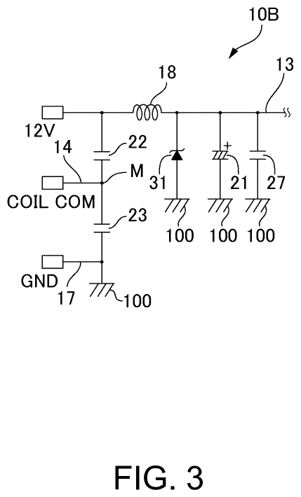

Here, the noise in a motor including the motor control unit 10 of the present embodiment and the noise in a motor including a motor control unit 10B of a comparative example will be described. FIG. 3 is a schematic circuit diagram of the motor control unit 10B of the comparative example. The motor control unit 10B of the comparative example illustrated in FIG. 3 has the same configuration as the motor control unit 10 of the present embodiment except that the resistor 20 is not included and the electrostatic capacity C1 of each of the second capacitor 22 and the third capacitor 23 is different. In FIG. 3, the motor control part 11, the inverter 12, the control signal line 15, the FG output line 16, and the like are omitted. The electrostatic capacity C1 of each of the second capacitor 22 and the third capacitor 23 of the motor control unit 10B illustrated in FIG. 3 is 0.1 μF.

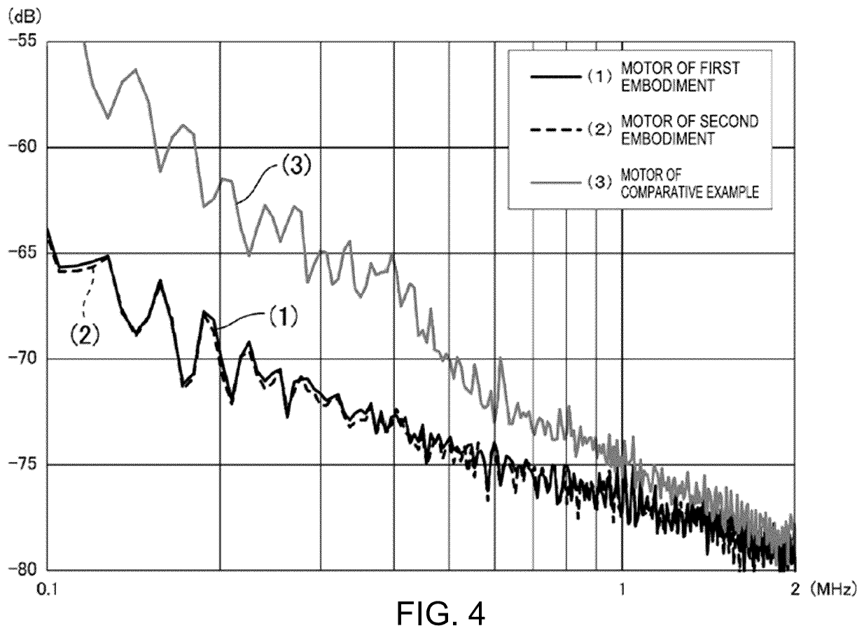

FIG. 4 is a diagram for explaining a noise-reduction effect. FIG. 4 illustrates results obtained by measuring noise levels generated from the motor including the motor control unit 10 of the present embodiment and the motor including the motor control unit 10B of the comparative example by a magnetic field antenna method test. In the motor control unit 10B of the present embodiment illustrated in FIG. 4, the resistance values Ra of the first resistor 201 and the second resistor 202 are 1 kΩ, and the electrostatic capacity C1 of each of the second capacitor 22 and the third capacitor 23 is 1.0 μF. As illustrated in FIG. 4, in the AM band (0.51 to 1.71 MHz), the noise generation is suppressed in the motor of the present embodiment as compared with the motor of the comparative example.

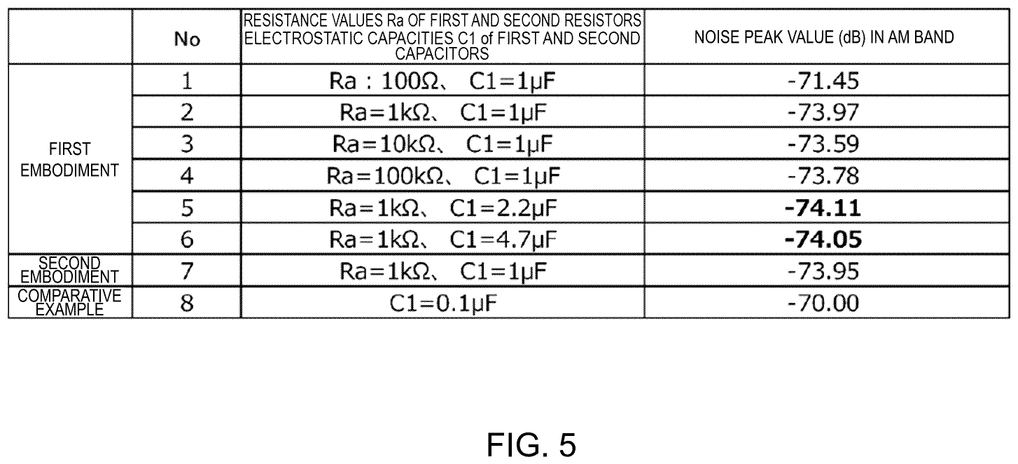

Next, the resistance value Ra and the electrostatic capacity C1 will be described. FIG. 5 is a diagram illustrating a noise peak value when the resistance value Ra and the electrostatic capacity C1 are changed. As illustrated in FIG. 5, when the resistance values Ra of the first resistor 201 and the second resistor 202 are set to 100Ω≤Ra, the motor of the present embodiment is able to suppress the noise peak value in the AM band as compared with the motor of the comparative example. Furthermore, when the resistance values Ra of the first resistor 201 and the second resistor 202 are set to 1 kΩ≤Ra, the motor of the present embodiment is able to suppress the noise peak value in the AM band by about 3 dB as compared with the motor of the comparative example, and thus the effect of suppressing the noise peak value in the AM band is larger. When each resistance value Ra is smaller than 100Ω, the effect of reducing the noise generated in the motor 2 cannot be sufficiently obtained.

Moreover, as illustrated in FIG. 5, when the electrostatic capacities C1 of the second capacitor 22 and the third capacitor 23 are set to 1.0 μF≤C1≤4.7 μF, the motor of the present embodiment is able to suppress the noise peak value in the AM band as compared with the motor of the comparative example. Furthermore, when the electrostatic capacities C1 of the second capacitor 22 and the third capacitor 23 are set to 2.0 μF≤C1≤4.7 μF, the motor of the present embodiment is able to further suppress the noise peak value in the AM band as compared with the motor of the comparative example. When each electrostatic capacity C1 is smaller than 1.0 μF, the voltage at the neutral point cannot be sufficiently smoothed, and the effect of reducing the noise generated in the motor cannot be sufficiently obtained. In addition, when the electrostatic capacity C1 is larger than 4.7 μF, the voltage at the neutral point is excessively smoothed, so that the rotation characteristics of the motor are relatively deteriorated.

The motor control unit 10 of the present embodiment has the control signal line 15 for inputting a PWM signal from an external device to the motor control part 11, and the fourth capacitor 24 electrically connected between the control signal line 15 and the ground 100. Therefore, since the PWM signal to be transmitted through the control signal line 15 is able to be smoothed, the noise generated in the control signal line 15 may be removed. Furthermore, the motor control unit 10 of the present embodiment has the ferrite bead 19 electrically connected in series to the control signal line 15 in a portion of the control signal line 15 closer to the output side than the fourth capacitor 24, and the sixth capacitor 26 electrically connected between the ground 100 and a portion of the control signal line 15 closer to the output side than the ferrite bead 19. According to this configuration, the noise generated in the control signal line 15 may be further removed.

The motor control unit 10 of the present embodiment has the FG output line 16 for transmitting a rotation speed signal corresponding to the rotation speed of the motor 2 to the external device, and the fifth capacitor 25 electrically connected between the FG output line 16 and the ground 100. Therefore, since the rotation speed signal to be transmitted through the FG output line 16 is able to be smoothed, the noise generated in the FG output line 16 may be removed.

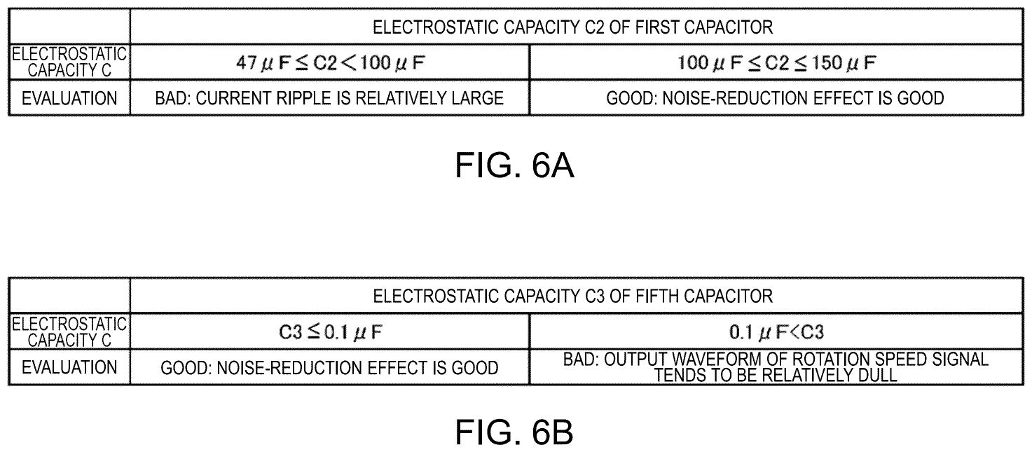

Here, the electrostatic capacities of the first capacitor 21 and the fifth capacitor 25 will be described. FIG. 6 is a diagram illustrating a comparison between the electrostatic capacities of the capacitors.

As illustrated in FIG. 6(A), when the electrostatic capacity C2 of the first capacitor 21 is smaller than 100 μF, the current ripple tends to be relatively large, and the drive voltage flowing through the drive voltage line 13 cannot be sufficiently smoothed. Thus, it is difficult to effectively suppress the noise generated in the drive voltage line 13. Therefore, in the present embodiment, since the electrostatic capacity C2 of the first capacitor 21 is 150 μF and satisfies 100 μF≤C2, the noise generated in the drive voltage line 13 may be suppressed. In addition, since the current ripple is suppressed, the first capacitor 21 does not excessively generate heat. Therefore, the characteristics and reliability of the first capacitor 21 are able to be ensured.

As illustrated in FIG. 6(B), when the electrostatic capacity C3 of the fifth capacitor 25 is larger than 0.1 μF, the noise generated in the FG output line 16 is able to be removed, but the output waveform of the rotation speed signal tends to be relatively dull. Thus, since the external device cannot accurately detect the rotation speed signal of the motor 2, it becomes difficult to control the motor 2 to a desired rotation speed. Therefore, in the present embodiment, since the electrostatic capacity C3 of the fifth capacitor 25 is 0.047 μF and satisfies C3≤0.1 μF, the noise generated in the FG output line 16 may be removed and the motor 2 may be controlled to a desired rotation speed.

Since the motor 2 of the present embodiment includes the motor control unit 10 described above, the noise generated in the motor 2 is suppressed. Accordingly, when the motor 2 of the present embodiment is used in the pump device 1, the noise generated from the pump device 1 is suppressed, and thus a precision device used around the pump device 1 is less likely to be affected by the noise. Although the case where the motor 2 is used in the pump device 1 has been described in the above embodiment, the motor 2 may be used for various purposes.

### Second Embodiment

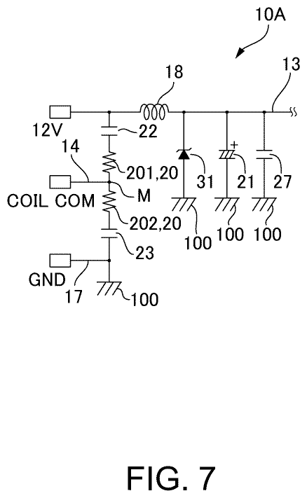

Next, a motor control unit 10A of a second embodiment will be described. The motor control unit 10A of the second embodiment is different from the motor control unit 10 of the first embodiment in that the positions at which the first resistor 201 and the second resistor 202 are arranged are different. Therefore, in the second embodiment, the same configurations as those in the first embodiment are denoted by the same reference numerals, and the description thereof may be omitted. FIG. 7 is a schematic circuit diagram of the motor control unit 10A of the second embodiment. In FIG. 7, the motor control part 11, the inverter 12, the control signal line 15, the FG output line 16, and the like are omitted.

As illustrated in FIG. 7, in the motor control unit 10A of the present embodiment, the resistor 20 includes the first resistor 201 electrically connected in series between the second capacitor 22 and the intermediate point M, and the second resistor 202 electrically connected in series between the intermediate point M and the third capacitor 23. In the present embodiment, the first resistor 201 and the second resistor 202 are configured by the same resistor. In the present embodiment, the resistance values Ra of the first resistor 201 and the second resistor 202 are 1 kΩ, and the electrostatic capacity C1 of each of the second capacitor 22 and the third capacitor 23 is 1.0 μF. As illustrated in FIG. 4, in the AM band (0.51 to 1.71 MHz), the noise generation is suppressed in the motor including the motor control unit 10A of the present embodiment as compared with the motor including the motor control unit 10B of the comparative example. Moreover, as illustrated in FIG. 5, the motor including the motor control unit 10A of the present embodiment is able to suppress the noise peak value in the AM band by about 4 dB as compared with the motor of the comparative example. Therefore, the motor including the motor control unit 10A of the present embodiment is able to obtain the same operation and effect as those of the first embodiment.

### Another Embodiment

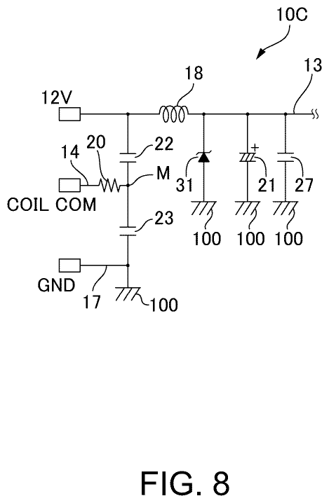

Next, another embodiment will be described. FIG. 8 is a schematic circuit diagram of a motor control unit 10C of the another embodiment. As illustrated in FIG. 8, one resistor 20 may be connected in series on the common line 14. Accordingly, the resistor 20 is electrically connected in series to the third capacitor 23. In this case, as in the above embodiments, the resistance value Ra of the resistor 20 is preferably 100Ω≤Ra. Accordingly, the present embodiment is able to also obtain the same operation and effect as those of the above embodiments.

The present technique may be configured as follows.

(1)

A motor control unit that controls a motor including a three-phase coil wound around a stator core, including:
a motor control part that controls rotation of the motor by a control signal;
an inverter that applies a drive voltage supplied from a drive power supply to the three-phase coil on the basis of an output signal from the motor control part;
a drive voltage line that supplies the drive voltage to the inverter;
an inductor electrically connected in series to the drive voltage line;
a first capacitor electrically connected between a ground and a portion of the drive voltage line between the inverter and the inductor;
a second capacitor electrically connected between the ground and a portion of the drive voltage line closer to an input side than the first capacitor;
a third capacitor electrically connected between the second capacitor and the ground;
a common line electrically connected to a neutral point of the three-phase coil and an intermediate point between the second capacitor and the third capacitor; and
a resistor electrically connected in series to the second capacitor or the third capacitor.
   (2)

The motor control unit according to (1), in which the resistor includes a first resistor electrically connected between a portion of the drive voltage line close to the input side and the second capacitor, and a second resistor electrically connected between the third capacitor and the ground.

(3)

The motor control unit according to (1), in which the resistor includes a first resistor electrically connected between the second capacitor and the intermediate point, and a second resistor electrically connected between the intermediate point and the third capacitor.

(4)

The motor control unit according to (1), in which the resistor is connected in series on the common line.

(5)

The motor control unit according to (2) or (3), in which, when a resistance value of each of the first resistor and the second resistor is Ra, the following conditional expression:

$$100 Ω \leq R a$$

is satisfied.
(6)

The motor control unit according to (4), in which, when a resistance value of the resistor is Ra, the following conditional expression:

$$100 Ω \leq R a$$

is satisfied.
(7)

The motor control unit according to any one of (1) to (6), in which, when an electrostatic capacity of each of the second capacitor and the third capacitor is C1, the following conditional expression:

$$1. μF \leq C 1 \leq 4.7 μF$$

is satisfied.
(8)

The motor control unit according to any one of (1) to (7), in which the second capacitor is electrically connected between the ground and a portion of the drive voltage line closer to the input side than the inductor.

(9)

The motor control unit according to any one of (1) to (8), in which, when an electrostatic capacity of the first capacitor is C2, the following conditional expression:

$$100 μF \leq C 2$$

is satisfied.
(10)

The motor control unit according to any one of (1) to (9), including:
a control signal line for inputting the control signal to the motor control part; and
a fourth capacitor electrically connected between the control signal line and the ground.
   (11)

The motor control unit according to (10), including:
a ferrite bead electrically connected in series to the control signal line in a portion of the control signal line closer to an input side than the fourth capacitor; and
a sixth capacitor electrically connected between the ground and a portion of the control signal line closer to the input side than the ferrite bead.
   (12)

The motor control unit according to any one of (1) to (11), including:
an FG output line for transmitting a rotation speed signal corresponding to a rotation speed of the motor to an external device; and
a fifth capacitor electrically connected between the FG output line and the ground.
   (13)

The motor control unit according to (12), in which, when an electrostatic capacity of the fifth capacitor is C3, the following conditional expression:

$$C 3 \leq 0.1 μF$$

is satisfied.
(14)

A motor including:
a rotor that is rotatable about a central axis;
a stator including a three-phase coil; and
the motor control unit according to any one of (1) to (13).
   (15)

A pump device including:
the motor according to (14);
an impeller fixed to the rotor; and
a case accommodating the impeller and defining a pump chamber.

### DESCRIPTION OF REFERENCE NUMERALS

1: pump device; 2: motor; 3: impeller; 4: case; 4A: pump chamber; 5: rotor; 6: three-phase coil; 7: stator; 8: resin sealing member; 9: circuit board; 10, 10A, 10B, 10C: motor control unit; 11: motor 5 control part; 12: inverter; 13: drive voltage line; 14: common line; 15: control signal line; 16: FG output line; 17: ground line; 18: inductor; 19: ferrite bead; 20: resistor; 21: first capacitor; 22: second capacitor; 23: third capacitor; 24: fourth capacitor; 25: fifth capacitor; 26: sixth capacitor; 61: U-phase coil; 62: V-phase coil; 63: W-phase coil; 65: neutral point; 70: stator core; 71: insulator; 100: ground; 201: first resistor; 202: second resistor; M: intermediate point

1. A motor control unit that controls a motor comprising a three-phase coil wound around a stator core, comprising:
a motor control part that controls rotation of the motor by a control signal;
an inverter that applies a drive voltage supplied from a drive power supply to the three-phase coil on the basis of an output signal from the motor control part;
a drive voltage line that supplies the drive voltage to the inverter;
an inductor electrically connected in series to the drive voltage line;
a first capacitor electrically connected between a ground and a portion of the drive voltage line between the inverter and the inductor;
a second capacitor electrically connected between the ground and a portion of the drive voltage line closer to an input side than the first capacitor;
a third capacitor electrically connected between the second capacitor and the ground;
a common line electrically connected to a neutral point of the three-phase coil and an intermediate point between the second capacitor and the third capacitor; and
a resistor electrically connected in series to the second capacitor or the third capacitor.

2. The motor control unit according to claim 1, wherein the resistor comprises a first resistor electrically connected between a portion of the drive voltage line close to the input side and the second capacitor, and a second resistor electrically connected between the third capacitor and the ground.

3. The motor control unit according to claim 1, wherein the resistor comprises a first resistor electrically connected between the second capacitor and the intermediate point, and a second resistor electrically connected between the intermediate point and the third capacitor.

4. The motor control unit according to claim 1, wherein the resistor is connected in series on the common line.

5. The motor control unit according to claim 2, wherein, when a resistance value of each of the first resistor and the second resistor is Ra, the following conditional expression:
$$100 Ω \leq R a$$
is satisfied.

6. The motor control unit according to claim 4, wherein, when a resistance value of the resistor is Ra, the following conditional expression:
$$100 Ω \leq R a$$
is satisfied.

7. The motor control unit according to claim 1, wherein, when an electrostatic capacity of each of the second capacitor and the third capacitor is C1, the following conditional expression:
$$1. μF \leq C 1 \leq 4.7 μF$$
is satisfied.

8. The motor control unit according to claim 1, wherein the second capacitor is electrically connected between the ground and a portion of the drive voltage line closer to an input side than the inductor.

9. The motor control unit according to claim 1, wherein, when an electrostatic capacity of the first capacitor is C2, the following conditional expression:
$$100 μF \leq C 2$$
is satisfied.

10. The motor control unit according to claim 1, comprising:
a control signal line for inputting the control signal to the motor control part; and
a fourth capacitor electrically connected between the control signal line and the ground.

11. The motor control unit according to claim 10, comprising:
a ferrite bead electrically connected in series to the control signal line in a portion of the control signal line closer to an input side than the fourth capacitor; and
a sixth capacitor electrically connected between the ground and a portion of the control signal line closer to an input side than the ferrite bead.

12. The motor control unit according to claim 1, comprising:
an FG output line for transmitting a rotation speed signal corresponding to a rotation speed of the motor to an external device; and
a fifth capacitor electrically connected between the FG output line and the ground.

13. The motor control unit according to claim 12, wherein, when an electrostatic capacity of the fifth capacitor is C3, the following conditional expression:
$$C 3 \leq 0.1 μF$$
is satisfied.

14. A motor comprising:
a rotor that is rotatable about a central axis;
a stator comprising a three-phase coil; and
the motor control unit according to claim 1.

15. A pump device comprising:
the motor according to claim 14;
an impeller fixed to the rotor, and
a case accommodating the impeller and defining a pump chamber.
